(19) United States
(12) Patent Application Publication
(10) Pub. No.: US 2005/0277407 A1
(43) Pub. Date: Dec. 15, 2005

(54) Method and device for providing mobile services with virtual number

(75) Inventors: Tae-Hyo Ahn, Seoul (KR); Hoon-Bae Kim, Seoul (KR); Ki-Chul Park, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: KTFREETEL CO., LTD., Seoul (KR)

(21) Appl. No.: 11/205,976

(22) Filed: Aug. 17, 2005

Related U.S. Application Data
(63) Continuation of application No. PCT/KR04/00327, filed on Feb. 18, 2004.

(30) Foreign Application Priority Data
Feb. 18, 2003 (KR) KR10-2003-0010089

(51) Int. Cl. H04Q 7/20

(52) U.S. Cl. 455/414.1; 455/403

(57) ABSTRACT

A method and device for providing a mobile subscriber with access to non-subscriber mobile services via the use of a virtual mobile phone number is disclosed. In one embodiment, the method comprises i) receiving a mobile service request from a user terminal, ii) determining whether or not the user is a home subscriber, iii) requesting that a virtual mobile phone number be provided if the user is a non-subscriber, iv) receiving the virtual mobile phone number from the user terminal, v) providing a corresponding mobile service if the received virtual phone number is verified, and vi) charging for use of the mobile service based on the virtual mobile phone number.

### RELATED APPLICATIONS

This application is a continuation application, and claims the benefit under 35 U.S.C. §§ 120 and 365 of PCT Application No. PCT/KR2004/000327, filed on Feb. 18, 2004 and published on Sep. 2, 2004, in English, which is hereby incorporated by reference.

### BACKGROUND OF THE INVENTION

1. Field of the Invention

The present invention relates to a method and device, with the use of a virtual number, for providing the same mobile service, which is provided to a subscriber of a mobile communication company, to a non-subscriber who receives mobile services from a different mobile communication company, and charging for use of such mobile services.

2. Description of the Related Technology

Generally, all of existing mobile service companies provide a mobile communication service only to a home subscriber who is registered at its own company, and for this, they confirm their subscriber with telephone number or mobile identification number (MIN) before providing service. That is, a user is required to purchase a mobile terminal and subscribe to a mobile service that a mobile communication company provides.

Now, we explain this problem with short message service (SMS) as an example. Although a non-subscriber or a subscriber without a mobile terminal can access websites of other mobile communication companies via a wired network, they cannot use SMS. Also, in the case of an enterprise-type SMS sender that sends many SMS messages in cooperating with a mobile communication company system through a dedicated line, the SMS sender is forced to buy plural mobile terminals of other mobile communication companies merely for the SMS billing. Also, since existing mobile communication companies can provide mobile services only to their own subscribers, a new subscriber needs to purchase its provider's mobile terminal which may be an obstacle to attract new subscribers. And, from the non-subscriber's perspective, since the mobile services are different from each mobile communication company, even if he or she wants to use other company's mobile service, there is no way to use it without changing the existing mobile communication service.

### SUMMARY OF CERTAIN INVENTIVE ASPECTS

One aspect of the present invention provides the same mobile service, which is provided to a home subscriber, to a non-subscriber with the use of a virtual number, and charge for such mobile service usage to the non-subscriber's terminal.

Another aspect of the present invention provides a method and device for providing the mobile service without changing a mobile terminal or subscribing another company service. Thus, the non-subscriber can use the mobile service of other companies, and the mobile communication company can easily attract new subscribers and increase profits therefrom.

Another aspect of the present invention provides a method and device for effectively issuing virtual numbers to non-subscribers.

Another aspect of the present invention provides a method in a mobile service server for providing a mobile service with a virtual number to a user terminal that accesses the mobile service server via a wired network. The method comprises: i) receiving a mobile service request from the user terminal, ii) determining whether or not the user is a home subscriber, iii) requesting a virtual number from the user terminal if the user is a non-subscriber according to the determination, iv) receiving the virtual number from the user terminal, v) providing a corresponding mobile service if the received virtual number is verified, and vi) charging for use of the mobile service based on the virtual number.

In one embodiment, the method can further comprise: i) receiving a request to issue a virtual number from the user terminal, ii) requesting user information including MIN of the user's mobile terminal, iii) receiving user information from the user terminal and storing the received user information, iv) transferring authentication information generated by use of the received MIN to the user's mobile terminal, v) identifying the user as a rightful owner of the mobile terminal by receiving a response signal corresponding to the authentication information from the mobile terminal, and vi) generating the virtual number and transferring the generated virtual number to at least one of the user terminal and the mobile terminal. In one embodiment, the virtual number is a virtual MIN.

Another aspect of the present invention provides a method of providing a mobile service with a virtual number to a non-subscriber's mobile terminal. The method comprises: i) receiving a request to access a mobile web server from the non-subscriber's mobile terminal, ii) extracting a virtual number by mapping MIN of the non-subscriber's mobile terminal with a predetermined virtual number, iii) accessing the mobile web server by use of the extracted virtual number, iv) receiving a corresponding mobile service from the mobile web server, and v) transferring the mobile service to the non-subscriber's mobile terminal by mapping the virtual number with the MIN of the non-subscriber's mobile terminal.

In one embodiment, the method can further comprise charging the mobile service usage by use of the virtual number. In one embodiment, the virtual number is either a virtual MIN or an electronic serial number (ESN), wherein the ESN is either an actual ESN or a virtual ESN.

In one embodiment, the method can further comprise: i)_receiving a request to issue a virtual number including MIN from the user terminal, ii) requesting a ESN corresponding to MIN to an ESN server, iii) receiving the ESN from the ESN server, and iv) assigning the virtual MIN corresponding to the ESN and storing the ESN and MIN.

Still another aspect of the present invention provides a device for providing a mobile service with a virtual number to a user terminal via a wired network. The device comprises: i) a virtual number providing part for issuing the virtual number to the user, ii) a virtual number database, being coupled to the virtual number providing part, for managing at least one of the virtual number and user information corresponding to the user, iii) a service providing part, being coupled to the virtual number providing part, for providing the mobile service to at least one of the user terminal and a mobile terminal, both belongs to the user who received the virtual number, and iv) a billing part, being coupled to the virtual number providing part and the service providing part, for charging a mobile service usage.

In one embodiment, the virtual number providing part i) requests user information including MIN of the user's mobile terminal to the user terminal when a request to issue a virtual number is received from the user terminal, ii) transfers authentication information generated by use of the received MIN to the user's mobile terminal after receiving user information from the user terminal and storing the received user information, iii) identifies the user as a rightful owner of the mobile terminal by receiving a response signal corresponding to the authentication information from the mobile terminal, and iv) transfers the generated virtual number to at least one of the user terminal and the mobile terminal after generating the virtual number,.

Yet another aspect of the present invention provides a device for providing a mobile service with a virtual number to a non-subscriber's mobile terminal. The device comprises: i) a virtual number providing part for issuing the virtual number to the non-subscriber's mobile terminal having MIN that was assigned by another mobile communication company, ii) a virtual number database, being coupled to the virtual number providing part, for managing at least one of the virtual number and a user information corresponding to the user, iii) a non-subscriber gateway, being coupled to the virtual number providing part, for mapping the MIN with the virtual number, accessing a mobile gateway by use of the virtual number, and transferring a data received from the mobile gateway to the non-subscriber's mobile terminal by use of the MIN, and iv) a mobile gateway, being coupled to the non-subscriber gateway, for accessing a mobile web server that the non-subscriber's terminal requested.

In one embodiment, the mobile gateway comprises a billing part for charging the mobile service usage to the non-subscriber's mobile terminal.

### BRIEF DESCRIPTION OF DRAWINGS

FIG. 1 shows a mobile service system with virtual number according to a first embodiment of the present invention.

FIG. 2 is a flowchart for providing the mobile service according to the first embodiment of the present invention.

FIG. 3 is a flowchart for providing the virtual number according to the first embodiment of the present invention.

FIG. 4 shows a table of virtual numbers according to the first embodiment of the present invention.

FIG. 5 shows a mobile service system with virtual number according to a second embodiment of the present invention.

FIG. 6 is a flowchart for providing the mobile service according to the second embodiment of the present invention.

FIG. 7 is a flowchart for providing the virtual number according to the second embodiment of the present invention.

FIG. 8 shows a table of virtual numbers according to the second embodiment of the present invention.

### DETAILED DESCRIPTION OF CERTAIN INVENTIVE EMBODIMENTS

The present invention relates to a method and device with virtual number for providing the same mobile service provided by the subscriber's mobile communication company to a virtual number subscriber who is a non-subscriber but has a virtual number and charging for the use of such mobile services. The mobile service comprises not only a voice call service but also all kinds of additional services such as SMS, long message service (LMS), multimedia message service (MMS), and ring back tone service, etc.

There are two exemplary embodiments for the method of providing mobile services with virtual number. The first embodiment relates to a method of providing the mobile service to the virtual number subscriber who accesses the mobile communication company via a wired network. The second embodiment relates to a method of providing the mobile service to the mobile terminal of a virtual number subscriber who accesses the mobile communication company via a mobile communication network.

Hereinafter, embodiments of the present invention will be described with accompanying drawings. In describing drawings, the reference number for the same element will be used as same number throughout specification, and same description for the element will be omitted.

<The First Embodiment>

Generally, when mobile services are provided on the web site via wired network, only home subscriber can use those mobile services. And, since the mobile services are different from each mobile communication company, even if he or she wants to use other company's mobile services, there is no way to use them without changing to the mobile communication company he or she wants.

According to one embodiment of the present invention, without changing a mobile terminal or joining to another mobile communication company, the mobile service can be provided to a virtual number subscriber(for the sake of description, hereinafter the term virtual number subscriber will be changed to ‘non-subscriber’). Hereinafter, the first embodiment will be described with accompanying drawings.

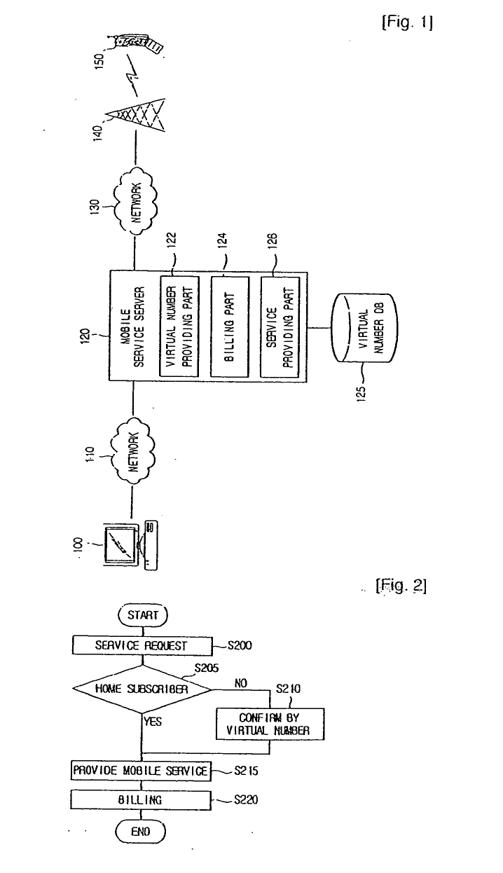

FIG. 1 shows a mobile service system with virtual number according to a first embodiment of the present invention.

In the first embodiment, the virtual number means a virtual MIN. MIN is 34-bit digital number for indicating a 10-digit telephone number of mobile terminal, and consists of MIN1 and MIN2. MIN1 consists of 24 bits for indicating the 7 digit telephone number of the mobile terminal, and MIN2 consists of 10 bits for indicating the area code. In 016-YYY-XXXX, YYY-XXXX is MIN1 and 016 is MIN2. In one embodiment the virtual MIN system can be varied with various MIN systems.

Referring to FIG. 1, the mobile service system with virtual number of the first embodiment comprises a user terminal 100, a mobile service server 120, BSC 140 and a called terminal 150, and the user terminal 100, the mobile service server 120 and BSC 140 are connected to each other through network 110.

The mobile service server 120 consists of a virtual number providing part 122, a billing part 124 and a service providing part 126. The virtual number providing part 122 provides the virtual number through the predetermined authentication method. The virtual number has the same format of MIN. The billing part 124 charges to the user who receives the virtual number based on user information, and performs mapping of user information and the virtual number.

The service providing part 126 provides the mobile service to the user who received the virtual number and accessed to the web site via the wired network, and the mobile service is a message transfer such as SMS, an intro page service and so on. The mobile service server 120 further comprises a virtual number database 125 storing the virtual number assigned to the non-subscriber and user information relevant to user information (FIG 4).

FIG. 2 is a flowchart for providing the mobile service according to the first embodiment of the present invention.

Referring to FIG. 2, if the user accesses to the mobile service server 120 by the user terminal 100 and requests the mobile service at step S200, the mobile service server 120 determines whether or not the user is a home subscriber at step S205.

If the user is a home subscriber according to the determination, the mobile service server 120 provides the mobile service by the conventional method and charges for the mobile service to the home subscriber at step S215. And if the user is not a home subscriber according to the determination, the mobile service server requests the virtual number to the user and determines whether or not the user is a non-subscriber at step S210. Then at step S215 the mobile service server provides the mobile service to the non-subscriber in the same method of providing the mobile service to the home subscriber. At step 220 the mobile service server charges for the mobile service based on the virtual number. The mobile service server stores user information corresponding to the virtual number when the virtual number is provided to the non-subscriber, and the charging therefor is performed by using user information. Hereinafter, the procedure of providing the virtual number will be described.

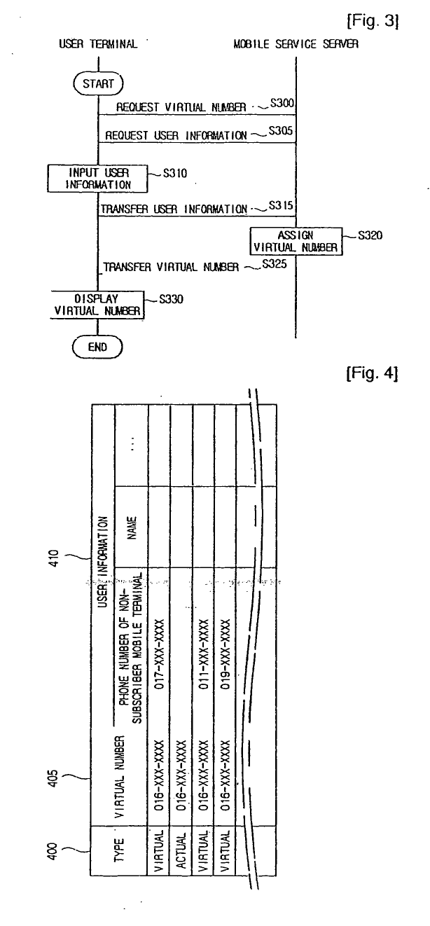

FIG. 3 is a flowchart of providing the virtual number according to the first embodiment of the present invention.

In order to provide the mobile service to the non-subscriber or the home subscriber without a mobile terminal, the authentication procedure to issue the virtual number must precede to provide the mobile service. The non-subscriber can receive the virtual number by subscribing the virtual number in offline or a contract between the mobile service companies for providing user information that they already have. In this specification, we describe the procedure of issuing the virtual number through the user terminal, namely, in online as an example.

If the user terminal requests to issue the virtual number to the mobile service server 120 at step S300, the mobile service server 120 requests user information to the user terminal at step S305. When the user inputs user information to the user terminal at step S315, the user terminal transfers user information to the mobile service server 120 at step S315.

On receiving user information, the mobile service server 120 permits the user as a new member ‘the non-subscriber’ and provides ‘unused number’, which is not used currently by the mobile communication company, as the virtual number to the user. Of course, the above-mentioned procedure of providing the virtual number can be accomplished in another simple way. Namely, the mobile service server requests only MIN among user information, and on receiving MIN, transfers authentication information for charging to the user's mobile terminal corresponding to MIN. Then, the mobile server receives authentication information from the user's mobile terminal to confirm the user, and provides the virtual number if authentication information is valid. In this embodiment, the authentication will be accomplished by transferring received authentication information, or a response signal corresponding to authentication information. The response can be authentication information itself or other information corresponding to authentication information.

When the mobile service server 120 transfers the virtual number to the mobile terminal at step S325, the mobile terminal can display the received virtual number.

FIG. 4 shows a table of virtual numbers according to the first embodiment of the present invention. The virtual number database 125 is coupled to the mobile service server 120 and stores the assigned virtual number and corresponding user information.

Referring to FIG. 4, the virtual number table comprises a type field 400, a virtual number field 405, and a user information field 410. The type field 400 indicates that the user is the subscriber who has a mobile terminal registered to the mobile communication company or not. In FIG. 4, although the virtual number table can include the home subscriber, it is also possible that the virtual number table only includes the non-subscriber without the type field 400.

The virtual number field 405 includes information of the virtual number being assigned by the mobile service server 120, and the virtual number in the first embodiment means MIN.

The user information field 410 includes user information of the non-subscriber. User information can comprise a name, a social security number, an address, charging information, and a MIN of non-subscriber's mobile terminal.

<The Second Embodiment>

Since it was impossible for the subscriber of one mobile communication company to access to other company's systems, there is no way to use mobile services of other companies. But, according to one embodiment of the present invention, the user having a mobile terminal can access a mobile communication network of other companies and use their mobile services. To provide the mobile service of other companies can contribute to collect new subscribers and to increase profits therefrom. Hereinafter, the second embodiment of the present invention will be described with accompanying drawings.

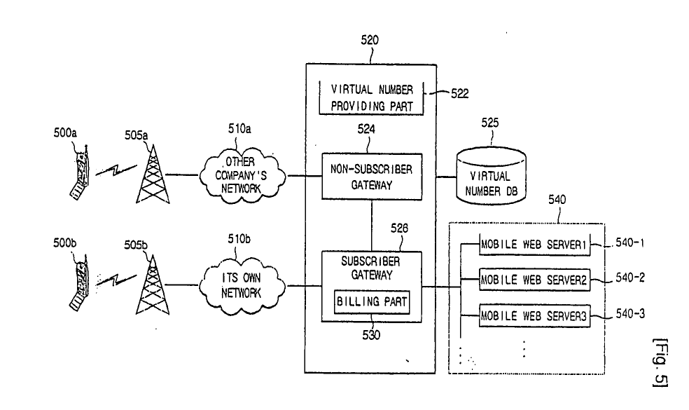

FIG. 5 shows a mobile service system with virtual number according to a second embodiment of the present invention. In the second embodiment, the virtual number can be ESN(electronic serial number) as well as the virtual MIN. ESN is 32-bit number, which is assigned by the mobile terminal manufacturer to each mobile terminal, for identifying the mobile terminal.

In the second embodiment that is performed in the mobile communication network, it is possible to authenticate the mobile terminal only with MIN or together with MIN and ESN. Thus, the virtual number of the second embodiment can include at least one of MIN and ESN. ESN can be the actual ESN or the virtual ESN as same as the virtual MIN. Hereinafter, we will describe the second embodiment of the mobile service system with virtual number and with a mobile web service as an example of the mobile service.

Referring to FIG. 5, the mobile service system with virtual number according to the second embodiment comprises mobile terminals 500a, 500b, BSC 505a, 505b, a mobile service server 520 and a mobile web server 540.

The mobile terminals 500a, 500b comprises a non-subscriber's mobile terminal 500a and a home subscriber's mobile terminal 500b. The non-subscriber's mobile terminal 500a can access to the mobile gateway 526 through another company's BSC 505a, another company's mobile communication network 510a and a non-subscriber gateway524.

And the home subscriber terminal 500b can access to the mobile gateway 526 through its own BSC 505b and mobile communication network 510b. The mobile terminals 500a, 500b that access to the mobile gateway 526 can use various mobile web services from its own mobile web server 540. The mobile web server 540 means individual web servers of mobile Internet, and comprises at least one web server of 540-1, 540-2, 540-3.

The mobile service server 520 comprises the virtual number providing part 522, the non-subscriber gateway 524 and the mobile gateway 526. The virtual number providing part 522 provides the virtual number based on the predetermined authentication method.

The non-subscriber gateway 524 performs a mapping between another company's telephone number and the virtual number. In more detail, the non-subscriber gateway 524 extracts the virtual number that was matched to MIN of another company and requests an access to the mobile web server 540 to the mobile gateway 526 by the extracted virtual number. That is, when the non-subscriber's mobile terminal 500a accessed to the non-subscriber gateway 524 through the other company's mobile communication network 510a, the non-subscriber gateway 524 extracts the virtual number from the virtual number database 525, accesses to the mobile gateway 526 by the extracted virtual number, and then processes the request for mobile service from the non-subscriber's terminal as same as that of the home subscriber's mobile terminal. And, the non-subscriber gateway 524 processes the signal to be transferred to the non-subscriber's terminal 500a by the same method of processing call signal from other company's mobile terminal.

The mobile gateway 526 performs an accessing process to the mobile web server 540 and a billing process. And, in order to help the non-subscriber to use the mobile Internet, it is possible to set up a proxy server and a port number in each non-subscriber's mobile terminal for accessing another company's mobile gateway 524. Thus, the link between the non-subscriber's terminal 500a and the non-subscriber gateway 524 is processed by MIN of the another company and the link between the non-subscriber gateway 524 and the mobile web server 540 is processed by the virtual number.

According to the billing structure of the embodiment, another company can charge for the usage of network and the virtual number service providing company can charge for the usage of mobile service by the billing part 530 in the mobile gateway 526.

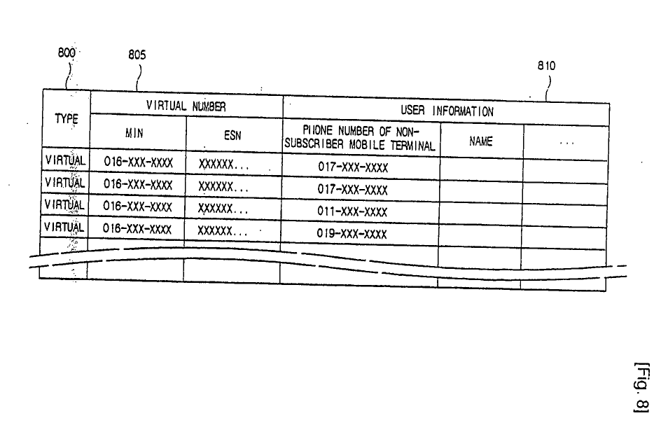

And, the mobile service server 520 comprises the virtual number database 525, wherein the virtual numbers have directly one-to-one match with MINs of non-subscriber's mobile terminal. In one embodiment of the present invention, the matching relationship of the virtual number can be constructed on the whole subscriber database or be included in HLR. Also, it can be managed in the form of a separated database. The assigned virtual number and corresponding user information will be described in FIG. 8.

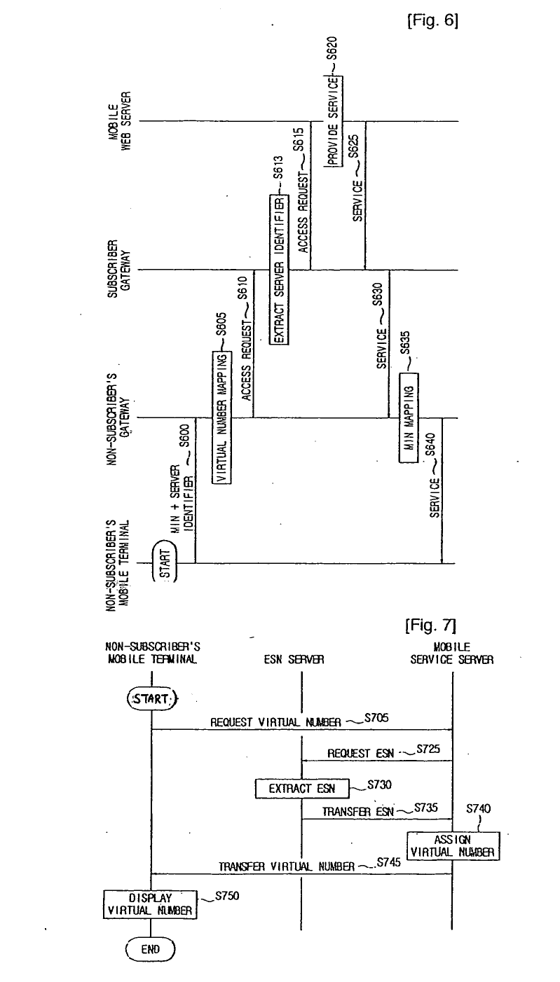

FIG. 6 is a flowchart for providing the mobile service according to the second embodiment of the present invention. Referring FIG. 6, the non-subscriber's mobile terminal 500a accesses to the non-subscriber gateway 524 at step S600. The non-subscriber terminal 500a transfers its phone number and a server identifier indicating the mobile web server that the non-subscriber wants to access. The phone number comprises at least one of MIN and ESN.

The non-subscriber gateway 524 extracts the virtual number corresponding to MIN at step S605, and requests an access to the mobile web server after accessing to the mobile gateway 526 with the extracted virtual number at step S610. The mobile gateway 526 identifies the requested mobile web server by extracting the server identifier at step S613, and accesses to the mobile web server at step S615.

The mobile web server processes the operation corresponding to a request from the non-subscriber's mobile terminal 500a at step S620, and transfers the result of operation to the mobile gateway 526 at step S625. The result of operation transferred from the mobile gateway 526 is further transferred to the non-subscriber gateway 524 at step S630.

At step S635, the non-subscriber gateway performs the mapping the virtual number with MIN of the non-subscriber's terminal 500a, and transfers the result of operation to the non-subscriber's terminal by using MIN at step S640. Here, the billing part 530 of the mobile gateway performs the billing process for that service.

FIG. 7 is a flowchart of providing the virtual number according to the second embodiment of the present invention. Same as the first embodiment, in order to provide the mobile service to the non-subscriber or the home subscriber without a mobile terminal, the authentication procedure to issue the virtual number must precede providing the mobile service. The non-subscriber can receive the virtual number by subscribing the virtual number in offline or a contract between the mobile service companies for providing user information that they already have. In FIG. 7, we describe the procedure of issuing the virtual number including ESN.

At step S700, the non-subscriber's mobile terminal 500a requests to issue the virtual number, including MIN or ESN if necessary, to the mobile service server 520. Hereinafter, we will describe the case that the non-subscriber's terminal sends only MIN.

At step S725, the mobile service server 520 transfers ESN request including the phone number to another company's ESN server corresponding to the non-subscriber's mobile terminal 500a. At step S730, the ESN server extracts ESN corresponding to MIN, and at step S740 transfers the extracted ESN to the mobile service server 520.

At step S740, the mobile service server 520 generates a virtual MIN and then the virtual number comprising the virtual MIN and actual ESN. At step S745, the mobile service server 520 transfers the assigned virtual number to the non-subscriber's terminal 500a, and at step S750, the mobile terminal 500a can display the virtual number on its screen.

FIG. 8 shows a mapping table of virtual numbers according to the second embodiment of the present invention. The virtual number database 525 is coupled to the mobile service server 520 and stores the assigned virtual numbers and corresponding user information.

Referring to FIG. 8, the virtual number table comprises the type field 800, the virtual number field 805, and the user information field 810. The virtual number table can store ESN field as well as MIN. Since the virtual number field 805 and the user information field 810 of FIG. 8 is same as those of FIG. 4, same description will be omitted.

According to embodiments of the invention, it is possible to provide same mobile service, which is provided to a home subscriber, to the non-subscriber with virtual number. Thus, the non-subscriber can use the mobile service of another mobile communication company without changing a mobile terminal or joining to another company. Since embodiments of the present invention can perform a billing corresponding to the usage of the mobile service, it is also possible to collect non-subscribers as its subscribers. And, one embodiment of the present invention provides a method and device for effectively issuing the virtual number to the non-subscribers.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

1. A method of providing a mobile service via a wired communication network, said method comprising:
receiving, at a mobile service server, a mobile service request from a user terminal;
determining whether or not a user of the terminal is a subscriber to the mobile service;
requesting that a virtual number be provided if the user is a non-subscriber;
receiving the virtual number from the user terminal;
providing a corresponding mobile service if the received virtual number is verified; and
charging for use of the mobile service based on the virtual number.

2. The method as stated in claim 1, further comprising:
receiving a request to issue a virtual number from the user terminal;
requesting user information including a mobile identification number (MIN) of a mobile terminal of the user;
receiving the user information from the user terminal and storing the received user information;
transmitting authentication information generated based on the received MIN to the mobile terminal;
verifying the user as a rightful owner of the mobile terminal based on a response signal corresponding to the authentication information received from the mobile terminal; and
generating and transmitting the virtual number to at least one of the user terminal and the mobile terminal.

3. The method as stated in claim 1, wherein said virtual number is a virtual MIN.

4. A method of providing a mobile service via a wireless communication network, said method comprising:
receiving a request to access a mobile web server from a mobile terminal, wherein a user of the mobile terminal is a non-subscriber to the mobile service, and wherein the request includes a mobile identification number (MIN) of the mobile terminal;
extracting a virtual number corresponding to the MIN;
accessing the mobile web server with the use of the extracted virtual number;
receiving a corresponding mobile service from the mobile web server;
restoring the MIN of the mobile terminal based on the virtual number; and
providing the corresponding mobile service to the mobile terminal based on the MIN.

5. The method as stated in claim 4, further comprising charging the mobile service usage based on the virtual number.

6. The method as stated in claim 4, wherein the virtual number is either a virtual MIN or an electronic serial number (ESN),
and wherein the ESN is either an actual ESN or a virtual ESN.

7. The method as stated in claim 4, further comprising:
receiving a request to issue a virtual number including a MIN from the mobile terminal;
requesting an ESN corresponding to the MIN from an ESN server;
receiving the ESN from the ESN server; and
assigning the virtual MIN corresponding to the ESN and storing the ESN and MIN.

8. A device for providing a mobile service via a wired network, the device comprising:
a virtual number providing part configured to issue a virtual number to a user terminal;
a virtual number database, being in data communication with said virtual number providing part, configured to manage at least one of the virtual number and user information corresponding to the user;
a service providing part, being in data communication with said virtual number providing part, configured to provide the mobile service to the user terminal; and
a billing part, being in data communication with said virtual number providing part and said service providing part, configured to charge a mobile service usage.

9. The device as stated in claim 8, wherein said virtual number providing part is configured to: i) request user information including a mobile identification number (MIN) of a mobile terminal of the user based on the user's request for a virtual number, ii) transmit authentication information generated based on the received MIN to the mobile terminal, iii) verify the user as a rightful owner of the mobile terminal based on a response signal, corresponding to the authentication information, received from the mobile terminal, and iv) transmit the generated virtual number to at least one of the user terminal and the mobile terminal.

10. A device for providing a mobile service via a wireless communication network, the device comprising:
a virtual number providing part configured to issue a virtual number to a mobile terminal, wherein a user of the mobile terminal is a non-subscriber to the mobile service, and wherein the virtual number is associated with a mobile identification number (MIN) of the mobile terminal;
a virtual number database, being in data communication with said virtual number providing part, configured to manage at least one of the virtual number and user information corresponding to the user;
a non-subscriber gateway, being in data communication with said virtual number providing part, configured to map the MIN with the virtual number, access a mobile gateway with the use of the virtual number, and transfer a data received from the mobile gateway to the mobile terminal based on the MIN; and
the mobile gateway, being in data communication with said non-subscriber gateway, configured to access a mobile web server, receive and forward a corresponding mobile service to the mobile terminal.

11. The device as stated in claim 10, wherein said mobile gateway comprises a billing part configured to charge the mobile service usage to the mobile terminal.

12. A method of providing a mobile service in a communication network, the method comprising:
receiving, at a mobile service server, a request for a mobile service from a user via the communication network, wherein a virtual mobile phone number, associated with a mobile terminal of the user, is stored on the mobile service server, and wherein the user is not registered as a subscriber to the mobile service; and
providing the user with the mobile service via the virtual mobile phone number.

13. The method as stated in claim 12, wherein the virtual mobile phone number is either a mobile identification number (MIN) or an electronic serial number (ESN) of the mobile terminal.

14. The method as stated in claim 12, further comprising billing the user for use of the mobile service based on the virtual mobile phone number.

15. The method as stated in claim 12, wherein the mobile service request is received from a user terminal via a wired communication network, and wherein the method further comprises:
determining whether or not the user is a subscriber to the mobile service when the user terminal accesses the mobile service server;
requesting that a virtual mobile phone number be provided if it is determined that the user is a non-subscriber;
receiving the virtual mobile phone number from the user terminal; and
providing a corresponding mobile service to the user terminal if the received virtual mobile phone number is verified.

16. The method as stated in claim 12, wherein the mobile service request is received from the mobile terminal, and wherein the method further comprises:
receiving a mobile identification number (MIN) from the mobile terminal;
extracting a virtual mobile phone number corresponding to the MIN;
accessing the mobile web server with the use of the extracted virtual mobile phone number;
receiving a corresponding mobile service from the mobile web server;
restoring the MIN of the mobile terminal based on the virtual mobile phone number; and
providing the corresponding mobile service to the mobile terminal based on the MIN.

17. A device for providing a mobile service in a communication network, the device comprising:
means for receiving, at a mobile service server, a request for a mobile service from a user via the communication network, wherein a virtual mobile phone number, associated with a mobile terminal of the user, is stored on the mobile service server, and wherein the user is not registered as a subscriber to the mobile service; and
means for providing the user with the mobile service via the virtual mobile phone number.
